(19) United States
(12) Patent Application Publication
(10) Pub. No.: US 2026/0368966 A1
(43) Pub. Date: Nov. 19, 2026

(54) METHOD AND ELECTRONIC APPARATUS WITH AUGMENTED IMAGE GENERATION

(71) Applicants: Samsung Electronics Co., Ltd., Suwon-si (KR); INDUSTRY-UNIVERSITY COOPERATION FOUNDATION HANYANG UNIVERSITY, Seoul (KR)

(72) Inventors: Seungju HAN, Suwon-si (KR); Taekyeong PARK, Seoul (KR); Jaehyuck CHOI, Seoul (KR); Je Hyeong HONG, Seoul (KR)

(73) Assignees: Samsung Electronics Co., Ltd., Suwon-si (KR); INDUSTRY-UNIVERSITY COOPERATION FOUNDATION HANYANG UNIVERSITY, Seoul (KR)

(21) Appl. No.: 19/402,149

(22) Filed: Nov. 26, 2025

(30) Foreign Application Priority Data
May 19, 2025 (KR) 10-2025-0064673

(51) Int. Cl. G06T 11/60; G06T 7/00

(52) U.S. Cl. CPC G06T 11/60; G06T 7/0002; G06T 2207/20081

(57) ABSTRACT

A processor-implemented method includes generating a first mask corresponding to a defect area identified based on defect scores for each of pixels of heatmap information corresponding to a defect image, generating a second mask from a model by using a prompt determined based on an array of the defect scores for each of the pixels, and generating an augmented image based on a normal image and one or more masks including either one or both of the first mask and the second mask.

### CROSS-REFERENCE TO RELATED APPLICATIONS

This application claims the benefit under 35 USC § 119 (a) of Korean Patent Application No. 10-2025-0064673, filed on May 19, 2025 in the Korean Intellectual Property Office, the entire disclosure of which is incorporated herein by reference for all purposes.

### BACKGROUND

### 1. Field

The following description relates to a method and an electronic apparatus with augmented image generation.

### 2. Description of Related Art

In various modern industrial environments, since defect data including a stain, an abnormality, an error and the like deteriorates productivity, yields, performance and the like in industrial sites compared to normal data, detection of defect data may be performed. Detecting such defect data may include using a model based on artificial intelligence (AI).

Meanwhile, in actual industrial environments, because defect data is obtained at a lower rate than normal data, difficulties exist in collecting defect data required for learning of (e.g., training) a model. That is, technology may not sufficiently guarantee defect data required for learning of a model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes generating a first mask corresponding to a defect area identified based on defect scores for each of pixels of heatmap information corresponding to a defect image, generating a second mask from a model by using a prompt determined based on an array of the defect scores for each of the pixels, and generating an augmented image based on a normal image and one or more masks including either one or both of the first mask and the second mask.

The first mask may correspond to a defect area comprising pixels corresponding to defect scores greater than or equal to a threshold value among the defect scores.

The threshold value may be adjusted based on the augmented image.

The generating of the second mask may include identifying a pixel with a highest defect score and a pixel with a lowest defect score according to the array of the defect scores for each of the pixels, identifying a third mask including the pixel with the lowest defect score, identifying whether each of a plurality of the pixels is included in the third mask in a descending order from the pixel with the highest defect score, and generating the second mask by using one or more pixels of the plurality of the pixels not included in the third mask.

The generating of the second mask by using the one or more pixels not included in the third mask may include determining information of the one or more pixels not included in the third mask, and generating the second mask by using a prompt determined based on the determined information.

The prompt may include the information with respect to the one or more pixels and a bounding box corresponding to the defect area.

The identifying of whether the each of the plurality of the pixels is included in the third mask may include identifying whether the each of the plurality of the pixels is included in the third mask until a number of the one or more pixels not included in the third mask reaches a reference number.

The generating of the augmented image based on the normal image and the one or more masks including either one or both of the first mask and the second mask may include generating the augmented image based on the normal image and a mask in which the first mask and the second mask are combined.

The generating of the augmented image based on the normal image and one or more masks including either one or both of the first mask and the second mask may include generating the augmented image based on the normal image and one mask selected from among the first mask and the second mask depending on a defect type corresponding to the defect image.

The augmented image may be used for classifying the defect type corresponding to the defect image.

The model may correspond to a segment anything model (SAM).

The generating of the augmented image based on the normal image and the one or more masks including either one or both of the first mask and the second mask may include adjusting one or more attributes including any one or any combination of any two or more of a size, a location, an angle, and a brightness of the one or more masks, and generating the augmented image based on the normal image and the one or more masks with the adjusted one or more attributes.

The method may include training, using the generated augmented image, a defect detection model to detect a defect of an input image.

In one or more general aspects, an electronic apparatus includes one or more processors comprising processing circuitry, and memory comprising one or more storage media storing instructions that, when executed individually or collectively by the one or more processors, cause the electronic device to generate a first mask corresponding to a defect area identified based on defect scores for each of pixels in heatmap information corresponding to a defect image, generate a second mask from a model by using a prompt determined based on an array of the defect scores for each of the pixels, and generate an augmented image based on a normal image and one or more masks including either one or both of the first mask and the second mask.

The first mask may correspond to a defect area comprising pixels corresponding to defect scores greater than or equal to a threshold value among the defect scores for each of the pixels.

For the generating of the second mask, the execution of the instructions may cause the electronic device to identify a pixel with a highest defect score and a pixel with a lowest defect score according to the array of the defect scores for each of the pixels, identify a third mask including the pixel with the lowest defect score, identify whether each of a plurality of the pixels is included in the third mask in a descending order from the pixel with the highest defect score, and

generate the second mask by using one or more pixels of the plurality of the pixels not included in the third mask.

For the generating of the second mask by using the pixel not included in the third mask, the execution of the instructions may cause the electronic device to determine information of the one or more pixels not included in the third mask, and generate the second mask by using a prompt determined based on the determined information.

The prompt may include the information with respect to the one or more pixels and a bounding box corresponding to the defect area.

The execution of the instructions may cause the electronic device to identify whether the each of the plurality of the pixels is included in the third mask until a number of the one or more pixels not included in the third mask reaches a reference number.

In one or more general aspects an electronic apparatus includes one or more processors comprising processing circuitry, and memory comprising one or more storage media storing instructions that, when executed individually or collectively by the one or more processors, cause the electronic device to detect a defect of an input image by using a defect detection model which has been trained based on an augmented image, wherein the augmented image is an augmented image generated based on a normal image and one or more masks including either one or both of a first mask corresponding to a defect area identified based on defect scores for each of pixels in heatmap information corresponding to a defect image, and a second mask generated from a model by using a prompt determined based on an array of the defect scores for each of the pixels.

Other features and aspects will be apparent from the following detailed description, the drawings, and the claims.

### BRIEF DESCRIPTION OF THE FIGURES

FIG. 1 is a drawing for describing generating an augmented image according to one or more embodiments.

FIG. 2 is a drawing for describing generating a second mask based on a model according to one or more embodiments.

FIG. 3 is a drawing for describing one or more embodiments utilizing an augmented image.

FIG. 4 is a drawing for describing generating a first mask corresponding to a defect area identified based on defect scores for each pixel according to one or more embodiments.

FIG. 5 is a drawing for describing generating a second mask based on a model according to one or more embodiments.

FIG. 6 is a flowchart for describing a method of obtaining an augmented image according to one or more embodiments.

FIG. 7 is a flowchart for describing generating a second mask based on a model (e.g., a model in the flowchart of FIG. 6) according to one or more embodiments.

FIG. 8 is a flowchart for describing generating a second mask using a prompt (e.g., a prompt in the flowchart of FIG. 7) according to one or more embodiments.

FIG. 9 is a block diagram for describing an electronic apparatus according to one or more embodiments.

FIG. 10 is a block diagram for a computing system including an electronic apparatus according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Furthermore, terms such as “ . . . unit” and “ . . . module” described in the specification mean hardware that processes at least one function or operation (e.g., hardware implementing software).

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains and specifically in the context on an understanding of the present disclosure. Terms, such as those defined in commonly used dictionaries, are to be interpreted as having a meaning that is consistent with their meaning in the context of and specifically in the context of the present disclosure, and are not to be construed to have an ideal or excessively formal meaning unless otherwise defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Hereinafter, example embodiments of the present disclosure will be described in detail with reference to the accompanying drawings in order for those of ordinary skill in the art to which the present disclosure pertains to easily implement example embodiments of the present disclosure. However, the present disclosure may be implemented in multiple different forms and is not limited to the example embodiments described herein.

Hereinafter, example embodiments of the present disclosure will be described in detail with reference to the drawings.

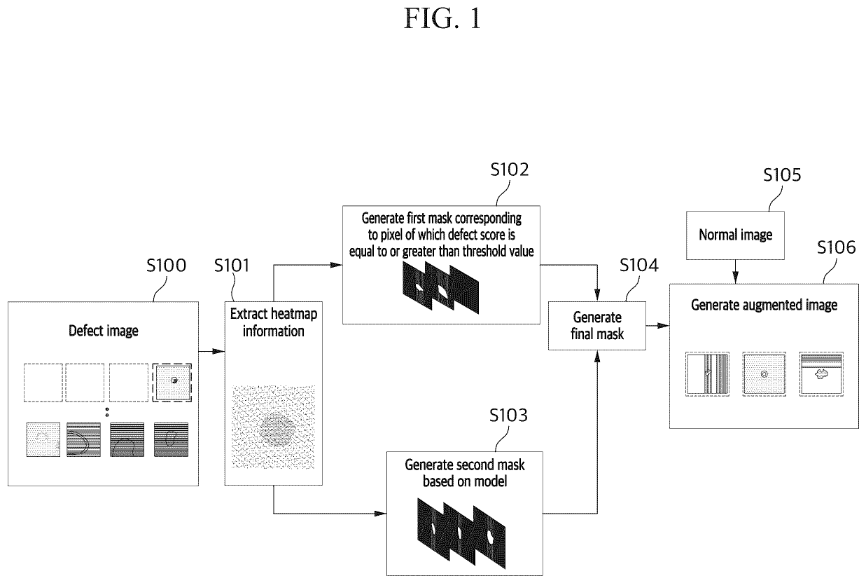

FIG. 1 is a drawing for describing generating an augmented image by using a normal image in which a defect does not exist and a mask with respect to a defect area according to one or more embodiments. Although one or more of operations of FIG. 1 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

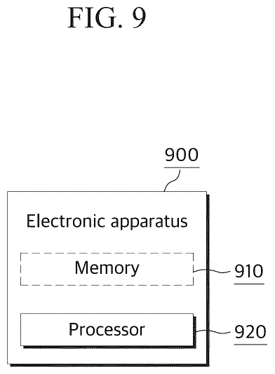

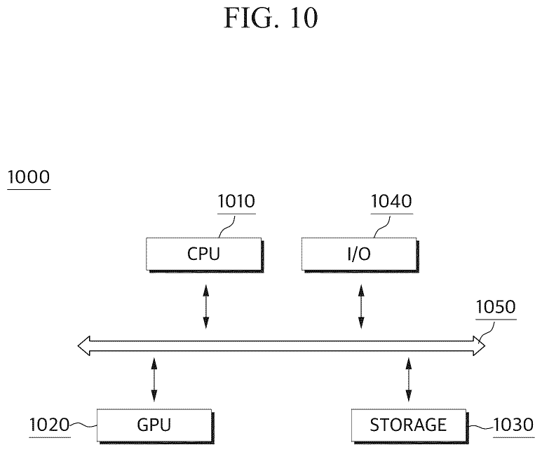

FIG. 1 may be performed in one or more processors, electronic apparatuses, modules and the like. As an example, FIG. 1 may be performed by an electronic apparatus 900 of FIG. 9, and/or may be performed by a processor corresponding to at least one between a central processing unit (CPU) 1010 and a graphic processing device (GPU) 1020 of FIG. 10.

According to one or more embodiments, in operation S100, an electronic apparatus may identify various defect images. Here, the defect image may signify an image including a defect. As an example, the defect image may be an image collected regardless of a type, shape, and size of a defect, and may correspond to an image including a part of a defect, and/or the entirety of a defect.

In operation S101, the electronic apparatus may extract heatmap information by receiving the various defect images as an input. Here, the electronic apparatus may extract the heatmap information for each defect image. For example, the electronic apparatus may respectively extract the heatmap information corresponding to each of the various defect images.

Meanwhile, the heatmap information may include information with respect to a pixel of an image described in a form of a heat distribution map. Here, a defect area including various shapes of defects (for instance, a line defect, a point defect, a surface defect, a volume defect and the like) may be expressed to be different from a normal area in the heatmap information. A pixel value of a defect area may be different from a pixel value of a normal area, and defect scores for each pixel may be determined based on each pixel value. Therefore, in the heatmap information, based on defect scores for each pixel, a defect degree (or a defect possibility or probability) may be identified for each pixel.

According to one or more embodiments, the heatmap information may be used for generating a first mask corresponding to a defect area of which a defect score is equal to or greater than a threshold value in a defect image, and a second mask based on a model. Here, the mask signifies to include a segmentation displaying a defect, and may include a signification as a pixel array belonging to a defect area at a center of a pixel of a defect image.

For example, in operation S102, the electronic apparatus may generate a first mask corresponding to one or more pixels of which a defect score is equal to or greater than the threshold value. Based on the defect scores for each pixel of heatmap information, a defect degree of each pixel may be identified, and a first mask corresponding to a defect area including one or more pixels of which a defect score is equal to or greater than the threshold value may be generated. Here, whether a defect exists in each pixel may be determined based on comparison between the threshold value and the defect scores for each pixel. For instance, a pixel having a defect score being equal to or greater than the threshold value may be included in a defect area, and a pixel having a defect score being less than the threshold value may be included in a normal area. Here, the threshold value may be determined according to a value inputted by a manager or a specific rule, and may be determined to be different based on a type or kind of a defect.

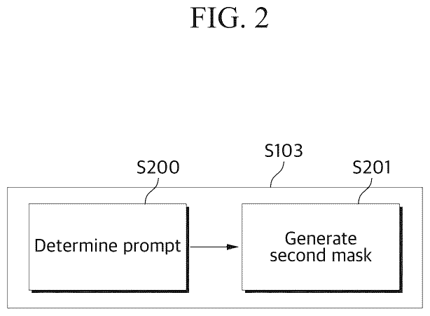

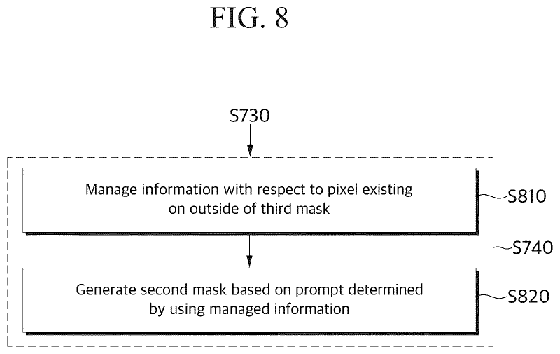

In operation S103, the electronic apparatus may generate a second mask based on a model. The heatmap information may be used in generating a second mask based on the model. Here, the model which may be used to generate a second mask may be any one or more of artificial intelligence-based various models (for instance, a segment anything model (SAM)). Here, by using a prompt determined based on an array of the defect scores for each pixel, a second mask may be generated from a model, and FIG. 2 and FIG. 8 may be referred to for detailed descriptions regarding thereto.

In operation S104, the electronic apparatus may generate a final mask by using at least one mask between the first mask based on operation S102 and the second mask based on operation S103.

Meanwhile, although FIG. 1 illustrates one or more embodiments in which all of the model-based second mask and the first mask corresponding to the one or more pixels of which the defect score is equal to or greater than the threshold value are generated, this corresponds to one or more embodiments of the present disclosure, and thus, the present disclosure is not limited thereto. For example, it is also possible that only one mask between the two masks is generated, and this may be determined by a type, a shape, a kind and the like of a defect included in the defect image.

For instance, in a case in which only one between the model-based second mask and the first mask corresponding to the one or more pixels of which the defect score is equal to or greater than the threshold value is generated, one mask may be used as a final mask as it is. Further, it is possible that only one mask between the two is used when the final mask is generated although all of the model-based second mask and the first mask corresponding to the one or more pixels of which the defect score is equal to or greater than the threshold value are generated. As another example, it is possible that all the two masks are used when the final mask is generated in response to all of the model-based second mask and the first mask corresponding to the one or more pixels of which the defect score is equal to or greater than the threshold value being generated.

Here, the number of generated masks, a type of masks, a determination type (for instance, an AND determination, an OR determination or the like with respect to a plurality of masks) for generating one final mask when a plurality of masks are generated and the like may vary depending on cases (for instance, a characteristic of a defect (for instance, a defect of a semiconductor wafer, a defect of a specific material or data and the like), a type of a defect (for instance, a line defect, a surface defect, a volume defect and the like), a kind of a defect or the like).

The electronic apparatus may identify a normal image in operation S105. Here, the normal image may correspond to an image which does not include a defect area.

The electronic apparatus may generate an augmented image by blending (e.g., combining) the final mask with the normal image in operation S106. The augmented image may correspond to a virtual defect image generated based on the final mask and the normal image.

Here, in operation S106, the electronic apparatus may adjust at least one of attributes including a size, a location, an angle, a brightness and the like of the final mask, and may generate the augmented image of various types by blending the normal image with the final mask with the adjusted attribute. Various methods may be applied in the blending process, and, for instance, an artificial intelligence model-based cutMix method may be applied in the blending process.

Hereinafter, different drawings may be referred to with respect to generating each mask and generating and utilizing an augmented image.

FIG. 2 is a drawing for describing generating a second mask based on a model according to one or more embodiments. For example, the same is a drawing for describing, in detail, the generating (operation S103) of the second mask based on the model in FIG. 1. Although one or more of operations of FIG. 2 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

In one or more embodiments, the generating (e.g., operation S103) of the second mask based on the model may include determining a prompt which is an input of the model in operation S200, and generating the second mask based on the corresponding prompt in operation S201.

The electronic apparatus may determine the prompt, which is an instruction with respect to an artificial intelligence-based model for generating the mask based on the heatmap information, in operation S200. Here, a type of the prompt may be in plural, and may include, for instance, a point which may correspond to each pixel of an image, a bounding box formed based on the point, and/or a segment with respect to a defect area, and may include various other types.

The electronic apparatus of one or more embodiments may determine an adequate prompt to increase precision and reliability of the artificial intelligence-based model. For instance, in order for the model to output a more accurate answer, the electronic apparatus of one or more embodiments may determine a negative prompt which indicates an incorrect answer with respect to an output value (e.g., an exclusion condition) and a positive prompt which indicates a correct answer with respect to an output value (e.g., an inducement condition) to be input to the model. Further, a bounding box, which corresponds to a defect area including one or more pixels of which a defect score is equal to or greater than the threshold value in the heatmap information, may be one of the positive prompts.

The electronic apparatus may determine the prompt by using a pixel with a highest defect score and a pixel with a lowest defect score in operation S200. For example, the electronic apparatus may, based on the heatmap information, arrange pixels in a descending order based on the defect scores for each pixel to identify the pixel with the lowest defect score and the pixel with the highest defect score. Here, the electronic apparatus may set the pixel with the lowest defect score as a negative prompt, and may set the pixel with the highest defect score as a positive prompt. The threshold value may be determined according to a value inputted by a manager or a specific rule as described above, and may be determined to be different based on a type and kind of a defect.

The electronic apparatus may identify (e.g., generate or receive) a third mask with respect to the pixel with the lowest defect score which may be used as the negative prompt in operation S200. The third mask may include pixels to be excluded from (e.g., not included in) the second mask. Further, the third mask may include the pixel with the lowest defect score. Here, the electronic apparatus may identify whether the pixel with the highest defect score is included in the third mask with respect to the pixel with the lowest defect score.

Here, in an order from the highest defect score, whether each pixel is included in the third mask with respect to the pixel with the lowest defect score may be identified. Here, a pixel included in the third mask may not be used for the second mask generation.

Further, identifying whether each pixel is included in the order from the highest defect score in the third mask with respect to the pixel with the lowest defect score may be repeated until the number of pixels, which are identified in the order from the highest defect score and do not exist in the third mask with respect to the pixel with the lowest defect score, reaches a reference number. Here, the reference number may correspond to a value determined to differ based on a value inputted by a manager, a value determined according to a specific rule, and/or a type or a kind of a defect.

Here, the electronic apparatus may not identify whether all pixels which are arranged in the descending order based on the defect scores are included in the third mask with respect to the pixel with the lowest defect score. For instance, in case that the reference number has been reached, identifying whether pixels are included in the third mask with respect to the pixel with the lowest defect score in the order from the highest defect score may be halted. For example, the reference number of pixels, which are not included in the third mask with respect to the pixel with the lowest defect score, may be used as a prompt for a model for generating the second mask. Further, other than the reference number of pixels, the third mask, which corresponds to a defect area including pixels of which a defect score is equal to or greater than the threshold value in the heatmap information, may be used as the prompt of the model along therewith.

For example, the electronic apparatus may determine the third mask, which corresponds to the defect area including the pixels of which the defect score is equal to or greater than the threshold value in the heatmap information and the reference number of pixels, which are not included in the bounding box with respect to the pixel with the lowest defect score, as the prompt in operation S200.

The electronic apparatus may generate the second mask for a defect by using the prompt in operation S201.

Meanwhile, various models may be applied for the artificial intelligence-based model for generating a second mask. For instance, the SAM may be applied as a model, and various other models may be applied.

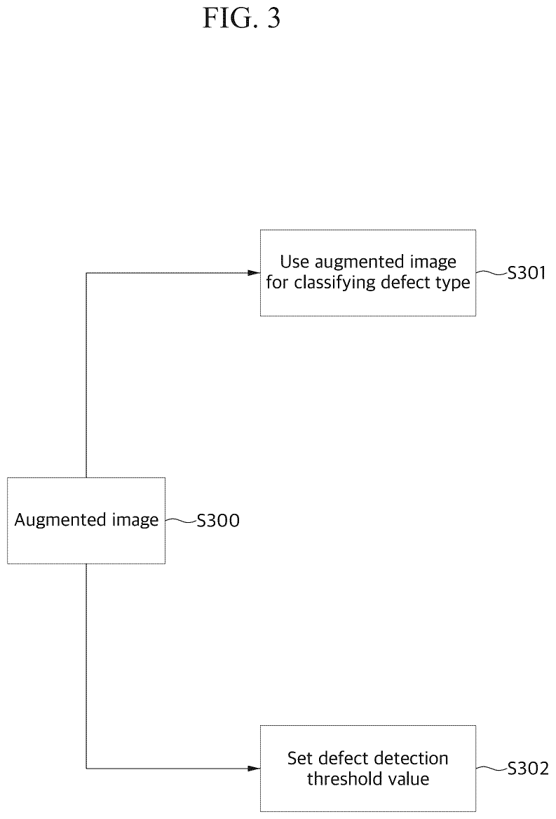

FIG. 3 is a drawing for describing one or more embodiments utilizing an augmented image. Although one or more of operations of FIG. 3 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

According to one or more embodiments, the electronic apparatus may identify an augmented image in operation S300. Here, the augmented image may include the augmented image generated by blending the final mask with the normal image in operation S106 in FIG. 1.

Here, the electronic apparatus may use the augmented image for classifying a type of a defect in operation S301. For example, the electronic apparatus may extract a defect not only from the defect image but also from the augmented image based on the final mask, and may train the artificial intelligence-based model, which classifies a type of a defect (e.g. a defect detection model), using the extracted defect and/or the augmented image. For example, operation S301 may be or include training, using the generated augmented image, the defect detection model to detect a defect of an input image. The training may include detecting a defect in the augmented image using the defect detection model, determining a loss based on a difference between the defect detected using the defect detection model and a ground truth defect corresponding to the augmented image using a loss function, and updating parameters (e.g., weights) of the defect detection model based on the loss using backpropagation. Here, the artificial intelligence-based model may be determined among various models such as not only the above-described SAM model but also a convolutional neural network (CNN).

Additionally or alternatively, the electronic apparatus may use the augmented image for setting the threshold value for detecting a defect in operation S302. The threshold value may be used in operation S102 for generating the first mask by comparing the defect scores to the threshold value, and may also be used in operation S103 for determining the prompt of the model. The threshold value may be set (e.g., updated) based also on the augmented image. Further, based on the updated threshold value, the electronic apparatus of one or more embodiments may improve precision of the mask (e.g., the mask generated in operation S102 and operation S103) for detecting a defect.

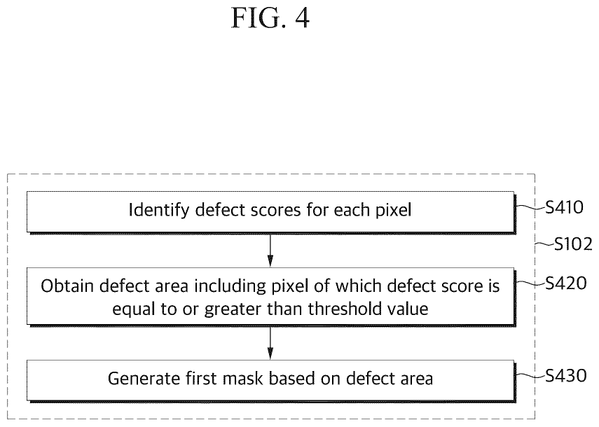

FIG. 4 is a drawing for describing generating a first mask corresponding to a defect area identified based on defect scores for each pixel according to one or more embodiments. For example, the same is a drawing for describing, in detail, operation S102 for generating the first mask corresponding to the one or more pixels of which the defect score is equal to or greater than the threshold value in FIG. 1. Although one or more of operations of FIG. 4 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

According to one or more embodiments, the electronic apparatus may identify the defect scores for each pixel from the heatmap information in operation S410. Here, the electronic apparatus may arrange pixels based on the descending order of the defect scores.

Here, in response to the defect scores for each pixel being identified, the electronic apparatus may obtain a defect area including one or more pixels of which a defect score is equal to or greater than the threshold value in operation S420. As described above, a defect area may be determined by identifying whether the defect scores for each pixel in the heatmap information are equal to or greater than the threshold value. Here, according to at least one of the number and distribution of one or more pixels of which a defect score is equal to or greater than a threshold value, and location information of the corresponding pixel, a shape and type (for instance, a point defect, a line defect and the like) and the like of the defect may be determined.

Further, the electronic apparatus may identify the one or more pixels of which the defect score corresponds to being equal to or greater than the threshold value among the pixels arranged based on the descending order of the defect scores in operation S420. The one or more pixels having a defect score equal to or greater than the threshold value may be included in the defect area. Here, the threshold value may be determined according to a value inputted by a manager or a specific rule, and may be determined to be different based on a type or kind of a defect.

In operation S430, the electronic apparatus may generate the first mask based on the defect area. For example, the electronic apparatus may generate the first mask by extracting the defect area including the one or more pixels of which the defect score is equal to or greater than the threshold value from the defect image.

One or more embodiments of FIG. 4 may be recorded in a computer-readable medium in a program form. Further, because FIG. 4 corresponds to one or more embodiments of the present disclosure, some operations may be added or omitted, and change in an order of some operations may also be included in one or more embodiments of the present disclosure.

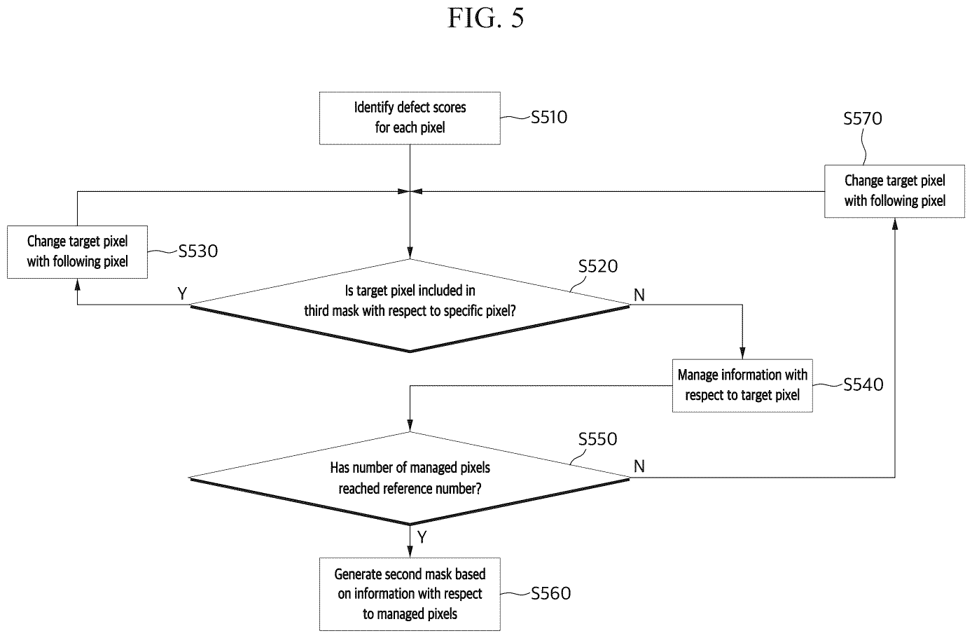

FIG. 5 is a drawing for describing generating a second mask based on a model according to one or more embodiments. For example, the same is a drawing for describing, in detail, generating of the second mask based on the model in operation S103 of FIG. 1. Although one or more of operations of FIG. 5 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

The electronic apparatus may identify the defect scores for each pixel in operation S510. The electronic apparatus may identify the defect scores for each pixel based on the heatmap information of the defect image, and may arrange the defect scores in the order from the highest defect score to the lowest defect score (e.g., in the descending order).

The electronic apparatus may identify whether a target pixel is included in a third mask with respect to a specific pixel in operation S520. Here, a first target pixel may be the pixel with the highest defect score among pixels arranged in the descending order of defect scores. Meanwhile, here, the specific pixel corresponding to the third mask may be the pixel with the lowest defect score among pixels arranged in the descending order. Here, the pixel with the lowest defect score may be a pixel with the lowest defect degree or defect possibility or probability. For example, in operation S520, the electronic apparatus may determine the specific pixel and the target pixel by arranging the defect scores in the descending order, identify the third mask with respect to the specific pixel, and identify whether the target pixel is included in the third mask with respect to the specific pixel.

In case that, in operation S520, when the target pixel is included in the third mask with respect to the specific pixel, the target pixel may be excluded from generating the second mask. Here, the electronic apparatus may, in operation S530, change the target pixel with a following pixel, and may repeat operation S520 again. Here, the specific pixel corresponds to the pixel with the lowest defect score among the pixels arranged in the descending order of the defect scores, and the target pixel may correspond to the pixel having a second-highest defect score to the pixel with the highest defect score. For example, the electronic apparatus may use the pixel with the second-highest defect score as the target pixel to repeat operation S520. In a case in which the pixel with the second-highest defect score is not included in the third mask with respect to the pixel with the lowest defect score as the target pixel, the same may be repeated with a pixel with a third-highest defect score being the target pixel. For example, the target pixel may be changed in the order from the highest defect score for the same to be repeated.

In case that, in operation S520, when the target pixel is not included in the third mask with respect to the specific pixel (for instance, in case that a target pixel with a high defect score is not included in the third mask with respect to the specific pixel with the lowest defect score), the target pixel may be included in the defect area. Therefore, in operation S540, the electronic apparatus may manage (e.g., determine) information with respect to the target pixel to use the target pixel in generating the second mask. Here, the managed information with respect to the target pixel may include location information of the target pixel (for instance, location information expressed in x, y coordinates in the defect image and the like), a defect score of the target pixel and the like.

Here, the electronic apparatus may identify whether the number of the managed pixels has reached the reference number in operation S550. Here, the reference number may be a value inputted by a manager, a value determined based on a form, type, kind and the like of a defect, and/or a value determined according to a specific rule. As an example, the form, type and the like of the defect may be determined based on at least one of the number of pixels of which a defect score is equal to or greater than the threshold value, distribution of the corresponding pixel, and location information thereof.

Meanwhile, as for the pixel used for generating the second mask, when the number of information managed for each pixel is 1 (for instance, location information of the pixel), because the number of the managed pixels and the number of the information managed for each pixel are identical, operation S550 may be replaced with identifying whether the number of the managed information, instead of the number of the managed pixels, reaches the reference number. Additionally, as another example, the reference number may be a value expressed with respect to the number of the managed information for each pixel. For instance, the reference number may be a value determined based on a value (for instance, a product (n*m) of the number (n number) of the managed information for each pixel and the total number (m number) of required pixels) based on both of the number of the managed information for each pixel, and the total number of the pixels.

Meanwhile, in a case in which the number of the managed pixels has not reached the reference number in operation S550, the electronic apparatus may change the target pixel with a following pixel in operation S570. Because it is to be identified whether each target pixel, which is determined in the order from the highest defect score, is included in the third mask until the number of the managed pixels reaches the reference number, the electronic apparatus may repeat the identifying by changing the target pixel with the pixel with the second-highest defect score. For instance, the electronic apparatus may manage information with respect to the target pixel with a pixel with an Nth highest defect score being the target pixel, and, in a case in which the number of the managed pixels has not reached the reference number, may repeat the identifying with a pixel with an N+1th highest defect score thereto being the target pixel. In a case in which a pixel with an N+Kth highest defect score thereto is a final pixel, the electronic apparatus may finish the process without repeating the same.

In operation S560, the electronic apparatus may generate the second mask based on information with respect to the managed pixels in a case in which the number of the managed pixels has reached the reference number. Here, in operation S560, the electronic apparatus may use a bounding box with respect to a heatmap information-based defect area along with the information with respect to the managed pixels as a prompt, and may generate the mask from the artificial intelligence-based model having the prompt and the heatmap information (or the defect image) as an input. For example, here, the bounding box with respect to the heatmap information-based defect area may be a bounding box with respect to a defect area including pixels of which a defect score is equal to or greater than the threshold value as described above.

Because FIG. 5 corresponds to one or more embodiments of the present disclosure, some operations may be added or omitted, and change in an order of some operations may also be included in one or more embodiments of the present disclosure.

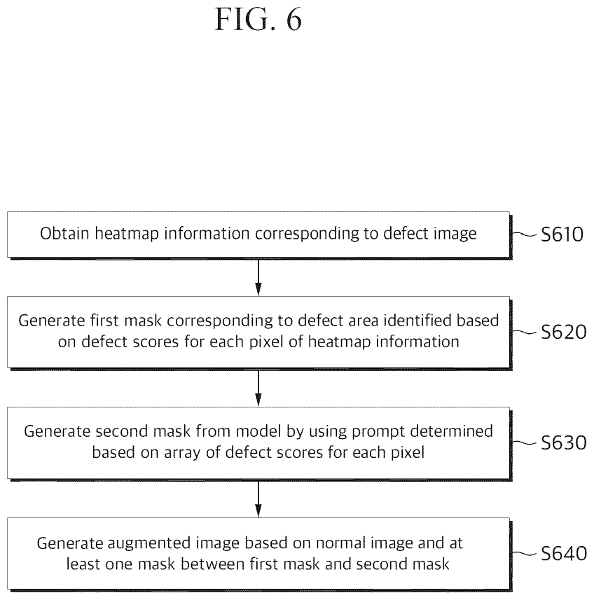

FIG. 6 is a drawing for describing a method of obtaining an augmented image according to one or more embodiments. The above-mentioned descriptions may be applied to a method of obtaining each augmented image of FIG. 6. Although one or more of operations of FIG. 6 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

FIG. 6 may be performed in at least one processors, electronic apparatuses, modules and the like. As an example, FIG. 6 may be performed by the electronic apparatus 900 of FIG. 9, and/or may be performed by a processor corresponding to at least one between the CPU 1010 and the GPU 1020 of FIG. 10.

As one or more embodiments, the electronic apparatus may obtain the heatmap information to correspond to each defect image in operation S610. The electronic apparatus may identify the defect scores for each pixel based on the heatmap information corresponding to each defect image.

The electronic apparatus may generate a first mask corresponding to a defect area identified based on the defect scores for each pixel of the heatmap information in operation S620. For example, the electronic apparatus may generate the first mask corresponding to the defect area including pixels having a defect score which is equal to or greater than the threshold value.

Meanwhile, the electronic apparatus may generate a second mask from a model by using a prompt determined based on an array of the defect scores for each pixel in operation S630. Here, the model for generating the second mask may include the above-mentioned artificial intelligence-based model (for instance, a SAM and the like). As described above, the electronic apparatus may use the information with respect to the reference number of the managed pixels and the bounding box corresponding to a heatmap-based defect area as the prompt, and may generate the second mask from the artificial intelligence-based model with the prompt and the heatmap information being an input.

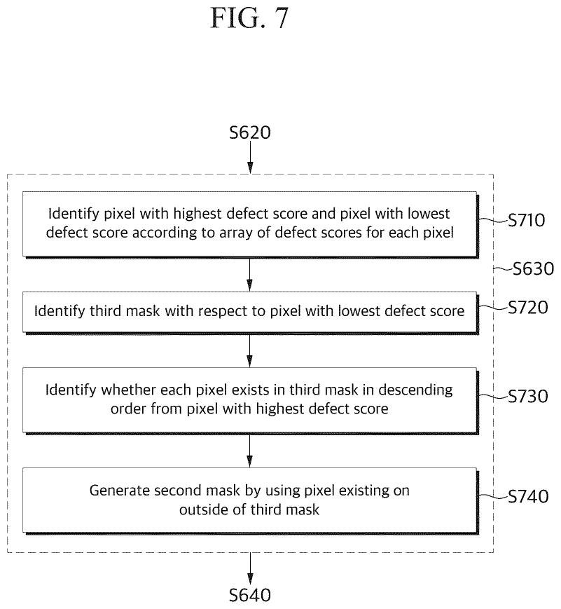

For example, the electronic apparatus may, in operation S630, identify the pixel with the highest defect score and the pixel with the lowest defect score according to the array of the defect scores for each pixel, identify the third mask with respect to the pixel with the lowest defect score, identify whether each pixel exists (e.g., is included) in the third mask in the descending order from the pixel with the highest defect score, and generate the second mask by using at least one pixel not included in the third mask (e.g., at least one pixel located beyond or outside of a boundary of the third mask). FIG. 7 may be referred to with respect to detailed descriptions regarding thereto.

Here, the electronic apparatus may manage information with respect to at least one pixel not included in of the third mask, and generate the second mask based on the prompt determined by using the managed information. FIG. 8 may be referred to with respect to detailed descriptions regarding thereto.

Meanwhile, the electronic apparatus may repeatedly perform identifying whether each pixel exists in the third mask until the number of the managed pixels (or the number of the information with respect to the managed pixels) reaches the reference number. For example, the electronic apparatus may not identify whether all pixels are included in the third mask with respect to the pixel with the lowest defect score depending on occasions. For example, without having to identify whether each of the all pixels arranged in the order from the highest defect score is included in the third mask with respect to the pixel with the lowest defect score, in a case in which the reference number has been reached, the repeated procedure may be halted.

The electronic apparatus may obtain the augmented image based on the normal image and at least one mask between the first mask and the second mask in operation S640. Here, by blending the normal image with the at least one mask between the first mask and the second mask, the augmented image, which is a virtual defect image, may be generated. Various methods may be applied in the blending process, and, for instance, the artificial intelligence model-based cutMix method may be applied in the blending process, and various other methods may be applied.

The augmented image obtained in operation S640 may be used for setting (for instance, updating) the threshold value for detecting a defect or for learning of (e.g., training) a model for classifying a type of a defect as described above.

Meanwhile, in operation S640, the electronic apparatus may generate the final mask by combining the first mask and the second mask, and may obtain the augmented image based on the final mask and the normal image. Here, the electronic apparatus may apply a specific determination (for instance, an AND determination, an OR determination or the like) with respect to two or more masks when the two or more masks are combined.

Unlike this, the electronic apparatus may obtain the augmented image based on the normal image and the at least one mask between the first mask and the second mask in operation S640. The electronic apparatus may select one mask between the first mask and the second mask according to a defect type, a defect characteristic or the like to correspond to a defect image, and may obtain the augmented image based on the selected mask and the normal image. Here, the defect characteristic may be a characteristic classified depending on, for instance, whether it is a defect of a semiconductor wafer or a defect of a specific material or data. Further, the defect type may include, for instance, types such as a line defect, a surface defect, a volume defect and the like.

Meanwhile, in operation S640, the electronic apparatus may, when blending the normal image with a mask, perform blending with the normal image without adjusting at least one mask between the first mask and the second mask. Alternatively, the electronic apparatus may adjust at least one of attributes including a size, a location, an angle, a brightness or the like of a mask, and may obtain the augmented image of various types by blending the normal image with the mask with the adjusted attribute.

One or more embodiments of FIG. 6 may be recorded in a computer-readable medium in a program form. Further, because FIG. 6 corresponds to one or more embodiments of the present disclosure, some operations may be added or omitted, and change in an order of some operations may also be included in one or more embodiments of the present disclosure.

FIG. 7 is a flowchart for describing generating a second mask based on a model (e.g., a model in the flowchart of FIG. 6) according to one or more embodiments. Although one or more of operations of FIG. 7 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

FIG. 7 is a drawing for describing, in detail, the generating of the second mask from the model by using the prompt determined based on the array of the defect scores for each pixel in operation S630 of FIG. 6.

As one or more embodiments, the electronic apparatus may identify the pixel with the highest defect score and the pixel with the lowest defect score according to the array of the defect scores for each pixel in the descending order based on the heatmap information in operation S710.

The electronic apparatus may check the third mask with respect to the pixel with the lowest defect score in operation S720.

The electronic apparatus may identify whether each pixel exists in the third mask with respect to the pixel with the lowest defect score in the descending order from the pixel with the highest defect score in operation S730. Here, as described above, in a case in which the target pixel exists in the third mask with respect to the specific pixel, the target pixel is not used for generating a second mask, and the target pixel may be changed with a following pixel with a second-highest defect score. Here, the following pixel is a pixel of which existence in the third mask is not identified yet, and may be a pixel with a second-highest defect score to the target pixel.

Meanwhile, the electronic apparatus may manage information with respect to the target pixel in a case in which the target pixel exists on the outside of the third mask with respect to the specific pixel in operation S730.

The electronic apparatus may repeatedly perform the identifying by changing the target pixel until the number of the target pixels not included in the third mask reaches the reference number in operation S730. Here, the reference number may be, for example, a value inputted by a user, and a shape, a type and the like of a defect may be a value determined based on at least one of the number of pixels of which a defect score is equal to or greater than the threshold value, and distribution of such pixels (based on, for instance, location information of the pixels of which the defect score is equal to or greater than the threshold value).

Therefore, the electronic apparatus may generate the second mask by using the pixel not included in the third mask with respect to the pixel with the lowest defect score in operation S740. The second mask may be blended with the normal image to be used in generating the augmented image.

One or more embodiments of FIG. 7 may be recorded in a computer-readable medium in a program form. Further, because FIG. 7 corresponds to one or more embodiments of the present disclosure, some operations may be added or omitted, and change in an order of some operations may also be included in one or more embodiments of the present disclosure.

FIG. 8 is a flowchart for describing generating a second mask using a prompt (e.g., a prompt in the flowchart of FIG. 7) according to one or more embodiments. Although one or more of operations of FIG. 8 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

FIG. 8 is a drawing for describing, in detail, the generating of the second mask by using the pixel not included in the third mask of operation S740 in FIG. 7.

As one or more embodiments, the electronic apparatus may manage information with respect to the pixel not included in the third mask in operation S810.

The electronic apparatus may generate a second mask based on the prompt determined by using the information with respect to the managed pixels in operation S820. The information with respect to the managed pixels may be information including location information of pixels, defect scores of pixels, the number of pixels and the like.

Meanwhile, along with the information with respect to the managed pixel, the bounding box corresponding to the heatmap-based defect area may be used as the prompt of the artificial intelligence-based model.

One or more embodiments of FIG. 8 may be recorded in a computer-readable medium in a program form. Further, because FIG. 8 corresponds to one or more embodiments of the present disclosure, some operations may be added or omitted, and change in an order of some operations may also be included in one or more embodiments of the present disclosure.

FIG. 9 is a block diagram for describing an electronic apparatus according to one or more embodiments.

Referring to FIG. 9, the electronic apparatus 900 may include a memory 910 (e.g., one or more memories) and a processor 920 (e.g., one or more processors) according to one or more embodiments. The memory 910 may be included in the electronic apparatus 900, but, without being limited thereto, may be located on the outside of the electronic apparatus 900. The processor 920 may be implemented as a single processor or a multi-processor. The processor 920 may be or include a general-purpose processor such as a central processing unit (CPU) (e.g., a CPU 1010 of FIG. 10), an application processor (AP), and a digital signal processor (DSP), a graphics-only processor such as a graphic processing unit (GPU) (e.g., a GPU 1020 of FIG. 10), a vision processing unit (VPU), and/or a neural network model-only processor such as a neural processing unit (NPU).

It will be understood by those of ordinary skill in the art to which the present example embodiment pertains those other universal elements may be further included other than the elements illustrated in FIG. 9. The above-mentioned descriptions may be applied to the electronic apparatus 900, and thus, duplicate descriptions will be omitted.

According to one or more embodiments, the processor 920 may control an overall operation of the electronic apparatus 900 and process data and signals. For example, the processor 920 may control the overall operation of the electronic apparatus 900 and process data and signals by using at least one instruction stored in the memory 910. For example, the memory 910 may be or include a non-transitory computer-readable storage medium storing instructions that, when executed by the processor 920, configure the processor 920 to perform any one, any combination, and/or all of the operations and/or methods described herein with reference to FIGS. 1-10.

Hereinafter, an example of an operation of the processor 920 in a case in which the electronic apparatus of FIG. 9 is an electronic apparatus generating an augmented image will be described.

As an example, the processor 920 may obtain the heatmap information including the defect scores for each pixel with respect to a defect image. An augmented image may be generated by using the normal image and a mask which is generated based on the heatmap information. Here, the mask generated based on the heatmap information may include at least one between a first mask corresponding to a defect area identified based on the defect scores for each pixel of the heatmap information and a second mask generated from a model by using the prompt determined based on the array of the defect scores for each pixel.

Further, the processor 920 may identify the third mask with respect to the pixel with the lowest defect score based on the heatmap information. Here, the processor 920 may identify whether each pixel exists in the third mask with respect to the pixel with the lowest defect score. The processor 920 may generate a second mask through the model based on information with respect to at least the reference number of the target pixels, which exist on the outside of the third mask, and generate an augmented image by using the mask and the normal image. Here, in a case in which the target pixel exists in the third mask, the target pixel may be excluded when the second mask is generated.

For example, the processor 920 may, when identifying whether each pixel exists in the third mask, identify the same in the descending order from a pixel with a highest defect score. Here, the processor 920 may repeatedly perform whether the target pixel exists in the third mask until the number of the target pixels which exist on the outside of the third mask (e.g., which do not exist in the third mask) reaches the reference number. For example, when the number of the target pixels which exist on the outside of the third mask reaches the reference number, the process repeated in the descending order from the pixel with the highest defect score may be halted, and thus, it may not be that whether all pixels are included in the third mask with respect to the pixel with the lowest defect score is identified. Meanwhile, as described above, the reference number may be determined according to attributes of a defect such as a defect type, a defect kind, a defect shape and the like of a defect image.

Here, the processor 920 may generate the second mask from the model by using the bounding box, including a defect area including pixels having a defect score equal to or greater than the threshold value which is identified based on the heatmap information and the information with respect to at least the reference number of the target pixels which exist on the outside of the third mask, as the prompt. Here, the second mask may be generated through the artificial intelligence-based model (for instance, the SAM and the like). Here, the threshold value may be a value determined based on attributes of a defect such as a defect type, a defect kind, a defect shape and the like of a defect image.

Here, the electronic apparatus may use at least one mask between a first mask corresponding to a defect area including pixels having a defect score equal to or greater than the threshold value and a second mask with which a mask generated based on the model. As an example, the processor 920 may be configured to select one mask between the first mask corresponding to the defect area including the pixels equal to or greater than the threshold value according to a defect type, a defect characteristic or the like corresponding to a defect image and the second mask with which the mask generated based on the model, and obtain an augmented image based on a selected mask and the normal image.

Here, the defect characteristic may be a characteristic according to whether it is, for instance, a defect of a semiconductor wafer, and/or a defect of a specific material or data. Further, the defect type may signify, for instance, a line defect, a surface defect, a volume defect and the like.

As another example, the processor 920 may generate the final mask by combining the first mask corresponding to the defect area including the pixels having the defect score equal to or greater than the threshold value based on the defect scores and the second mask generated based on the model. As an example, the processor 920 may perform a specific determination (for instance, an AND determination, an OR determination and the like) to generate the final mask.

Further, the processor 920 may generate the augmented image by blending a final mask and the normal image through the model. Various methods may be applied in the blending process, and for instance, the artificial intelligence model-based cutMix method may be applied in the blending process.

Meanwhile, when the normal image and the first mask, the second mask, and/or the final mask are blended, the mask may be used as it is without additionally changing an attribute, but a mask with an adjusted attribute, of which at least one of attributes including a size, a location, an angle, a brightness and the like is adjusted, may be blended with the normal image. Based on such an attribute adjustment, various augmented images may be obtained.

Here, the generated augmented image may be used for learning of a model for detecting a defect and classifying a defect type, and/or used for setting (for instance, updating) the threshold value for detecting a defect.

The processor 920 may generate a mask based on at least one combination of the above-mentioned example embodiments, generate an augmented image by using the mask and the normal image, and utilize the generated augmented image.

Further, the processor 920 may directly generate or obtain information to be sued for generation of a mask or generation of an augmented image, but may receive the same from the outside, and may transmit the same to another external electronic apparatus.

Hereinafter, an example of an operation of the processor 920 in a case in which the electronic apparatus of FIG. 9 is an electronic apparatus using the model which has learned by using the generated augmented image will be described.

The processor 920 may detect a defect of an input image by using the model which has learned based on the augmented image. Here, the input image includes both of a defect image which includes a defect and a normal image which does not include a defect, and may signify an image in which whether a defect is included is to be identified. The input image may be an image selected by a manager.

Further, as an example, the learned model may include the artificial intelligence-based model (for instance, the SAM and the like). Meanwhile, the learned model may be a model of which learning is performed by the processor 920 of FIG. 9, but may be a model existing on the outside (for instance, a server, a cloud and the like) of the electronic apparatus of FIG. 9. For example, the electronic apparatus of FIG. 9 may be a subject using the learned model in an example, but in another example, may be a subject generating and using the learned model.

As one or more embodiments, the augmented image used for learning of a model may be an augmented image generated based on the normal image and at least one mask between the first mask corresponding to a defect area identified based on the defect scores for each pixel in the heatmap information corresponding to a defect image, and the second mask generated from the model by using the prompt determined based on the array of the defect scores for each pixel. Here, the augmented image may be identical to the augmented image described in FIG. 1 to FIG. 8, and may be an augmented image generated by the electronic apparatus according to another example embodiment described above with reference to FIG. 9. Therefore, duplicate descriptions with respect to the augmented image will be omitted.

Meanwhile, the processor 920 may detect a defect of the input image by using the model which has learned based on the augmented image. As an example, the processor 920 may determine whether a defect exists with respect to the input image, and may classify a location of a defect, a type of a defect and the like. For instance, the processor 920 may be a subject executing operation S301 of FIG. 3.

When utilizing the augmented image generated based on various example embodiments disclosed in the present disclosure (for instance, using the same in classifying a defect of a wafer and the like), the electronic device of one or more embodiments may improve detection and classification performance with respect to defect data (for instance, a defect image) constituted with various sizes and backgrounds.

Further, although defect data is insufficient because the defect data is obtained at an extremely small proportion compared to normal data, according to various example embodiments disclosed in the present disclosure, the electronic device of one or more embodiments may generate an augmented image, which is a virtual defect image, any may train the artificial intelligence-based model using the generated augmented image, thereby resolving the insufficiency of the defect data, which is learning data, and thereby improving performance of the model by training the model using sufficient data.

Further, although typical electronic device may require a large amount of costs and time in collecting and labelling defect data required for learning of a model, according to various example embodiments disclosed in the present disclosure, the electronic device of one or more embodiments may generate an augmented image even without a ground-truth (GT) file, thereby improving efficiency in terms of cost, required processing time, and the like.

The following Table 1 below, for example, is defect classification performance when the augmented image generated according to one or more embodiments disclosed in the present disclosure is utilized for wafer defect detection, classification and the like, being compared to defect classification performance when an augmented image generated based on a typical method different from the one or more embodiments disclosed in the present disclosure is utilized for wafer defect detection, classification and like.

TABLE 1

| | | SEM wafer | | | | |
|---|---|---|---|---|---|---|
| | | Detection (%) | Classification (%) | | | |
| 3*Type | 3*Methods | Misclassification | Overall | Many | Medium | Few |
| 4*Loss-based | CE | 4.3 | 76.0 | 90.0 | 70.0 | 63.3 |
| | BS | 1.5 | 78.3 | 85.8 | 64.4 | 82.2 |
| | LADE | 4.7 | 76.7 | 90.0 | 60.0 | 75.6 |
| | LDAM | 4.3 | 78.0 | 89.2 | 62.2 | 78.9 |
| 2*Ensemble- | RIDE | 3.7 | 80.0 | 86.7 | 72.2 | 78.9 |
| based | SADE | 3.5 | 82.3 | 89.2 | 73.3 | 82.2 |
| Self- | GLMC | 1.0 | 83.0 | 93.3 | 75.6 | 76.7 |
| supervised- | | | | | | |
| based | | | | | | |
| PEFT based | PEL | 1.3 | 87.3 | 91.7 | 82.2 | 86.7 |
| SAM mask + | | — | 89.7 | 96.7 | 84.4 | 85.6 |
| cropped mask | | | | | | |

In Table 1 above, 3*Type may signify an applied method. The SAM mask+cropped mask item in the last row may correspond to a case in which a mask generated based on a model (for instance, a second mask) among example embodiments of the present disclosure and a mask generated based on a defect area including one or more pixels of which a defect score is equal to or greater than the threshold value in a heatmap (for instance, a first mask) are used in generation of an augmented image, detection of a wafer defect, classification and the like.

Here, Misclassification indicates a case in which an error has occurred during detection or search of a defect in a percent to an entire case, and may be determined based on both of a rate of having determined a part not having a defect as having a defect (for instance, a false positive rate (FPR)), and/or a rate of having determined a part having a defect as not having a defect (for instance, a false negative rate (FNR)).

As an example, the Overall item in Classification indicates an average classification accuracy of the pixel with the highest defect score in an entire class with respect to a defect image, and Many, Medium, and Few in Classification may respond to performance of a case in which the number of learning data (for instance, images) for classifying a defect exceeds 100 sheets, a case in which the number of the learning data exceeds 20 sheets but 100 sheets or less, and a case in which the number of the learning data is 20 sheets or less.

According to Table 1 above, SAM mask+cropped mask according to one or more embodiments disclosed in the present disclosure is compared to another model, in order for performance to be improved in terms of various aspects such as augmented image generation, wafer defect detection, classification, and the like.

FIG. 10 is a block diagram for a computing system including an electronic apparatus according to one or more embodiments.

It will be understood by those of ordinary skill in the art to which the present example embodiment pertains those other universal elements may be further included in a computing system 1000 other than the elements illustrated in FIG. 9. The computing system 1000 is an apparatus performing the above-mentioned method for obtaining the augmented image, and the above-mentioned descriptions will be referred to for duplicate descriptions.

Referring to FIG. 10, the computing system 1000 may include at least one processor (e.g., the CPU 1010, and the GPU 1020), a storage 1030, an input and output device 1040, and a data bus 1050.

Here, the at least one processor (e.g., the CPU 1010, and the GPU 1020) may include a first processor and a second processor. The first processor may include, as an example, the CPU 1010, and the second processor may include, as an example, the GPU 1020. Meanwhile, this is merely one or more embodiments, and the first processor may be implemented in other forms such as an application processor (AP), a digital signal processor (DSP), a microcontroller unit (MCU) and the like, and/or may further include another kind of a processor. The second processor may be implemented in other forms such as a neural processing unit (NPU), a tensor processing unit (TPU), an AI accelerator and the like, and/or may further include another kind of a processor.

The first processor may control an overall operation of the computing system 1000. The first processor may process universal data, and/or perform determination such as an arithmetic logic. The first processor may allocate or manage resources of the computing system 1000 by executing an operating system, and a firmware. The second processor is a processor having a structure advantageous in parallel processing, and may efficiently process determination with respect to the artificial intelligence-based model.

Therefore, the second processor may perform determination of outputting a second mask from a model by using the prompt determined based on the array of the defect scores for each pixel. The first processor may obtain the heatmap information corresponding to a defect image, and may perform determination of outputting a first mask corresponding to a defect area which is identified based on the defect scores for each pixel of the heatmap information. Further, the first processor may perform determination of outputting an augmented image based on a normal image and at least one mask between a mask outputted from the first processor (for instance, the first mask) and a mask outputted from the second processor (for instance, the second mask). Further, the first processor may perform determination of setting (for instance, updating) the threshold value for detecting a defect by utilizing the augmented image. Meanwhile, learning of a model for classification of a defect type by utilizing an augmented image may be performed at the second processor rather than at the first processor.

For example, determination with respect to the artificial intelligence-based model may be more efficiently processed at the second processor, in order to be used in using a model or causing the model to learn. For instance, in a case in which the artificial intelligence-based model is applied to detecting a defect by obtaining the heatmap information from a defect image, unlike what is above-mentioned, such an operation may be performed at the second processor rather than at the first processor.

For example, the first processor and the second processor may be linked to respectively perform partial determination of a method of obtaining an augmented image. Although a plurality of processors are illustrated in FIG. 10 as the CPU 1010 and the GPU 1020, the number of the processors may be modified into one in order for related determination to be executed. In this case, the processor may be implemented in a form of a system on chip (SoC) and the like, for instance.

The storage 1030 may store data. For instance, the storage 1030 may store at least a part of an artificial intelligence-based model, a defect image which is learning data, an augmented image, heatmap information, various masks and the like. Other than this, the storage 1030 may store application programs, an operating system (OS) image, and various kinds of related information.

The storage 1030 may be provided as a memory card (e.g., a multi-media card (MMC), an embedded multi-media card (eMMC), a secure digital (SD), a MicroSD and the like) or a hard-disk drive (HDD). The storage 1030 may include a not-AND (NAND)-type flash memory having a storage ability of a large capacity. Alternatively, the storage 1030 may transmit and receive data to and from the CPU 1010 and the GPU 1020 and may store data and/or instructions to be used for execution of a program. Here, the storage 1030 may be a volatile memory device such as a dynamic random access memory (DRAM), a synchronous dynamic random access memory (SDRAM), a double data rate (DDR) DRAM, a DDR SDRAM, a low power double data rate (LPDDR) SDRAM, a graphics double data rate (GDDR) SDRAM, a rambus dynamic random access memory (RDRAM), a static random access memory (SRAM) and the like. Alternatively, the storage 1030 may be implemented also in a non-volatile memory device such as a resistive random access memory (RRAM), a phase-change memory (a phase-change random access memory (PRAM)), a magnetic resistance memory (a magnetic random access memory (MRAM)), a ferroelectric memory (a ferroelectric random access memory (FRAM)), a spin injection flux reversal memory (a spin transfer torque random access memory (STT-RAM)) and the like.

The input and output device 1040 may include various input devices and output devices which enable an interaction between the computing system 1000 and a user. For instance, the input device may be implemented as a keyboard which detects a key input of the user, a mouse which detects a point input of the user, a touch panel which detects a touch input of the user and the like. For instance, the output device may be implemented as a display outputting video information such as an image, a text and the like, a speaker outputting sound information such as a voice, an alarm and the like, and the like.

The CPU 1010, the GPU 1020, the storage 1030 and the input and output device 1040 may be coupled to each other through the data bus 1050. The data bus 1050 may correspond to a path through which data move. A configuration of the data bus 1050 is not limited thereto, and may further include mediation means for efficient management.

According to one or more embodiments, the computing system 1000 may be applied to a system such as a notebook, a desktop, a laptop, a smartphone, a tablet PC, an MP3 player, a personal digital assistant (PDA), a portable multimedia player (PMP), a digital TV, a digital camera, a portable game console, a navigation device, a wearable device, a virtual reality (VR) device, an augmented reality (AR) device, a drone and the like.

The electronic apparatuses, memories, processors, computing systems, CPUs, GPUS, storages, input and output devices, data buses, electronic apparatus 900, memory 910, processor 920, computing system 1000, CPU 1010, GPU 1020, storage 1030, input and output device 1040, and data bus 1050 described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-10 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
generating a first mask corresponding to a defect area identified based on defect scores for each of pixels of heatmap information corresponding to a defect image;
generating a second mask from a model by using a prompt determined based on an array of the defect scores for each of the pixels; and
generating an augmented image based on a normal image and one or more masks including either one or both of the first mask and the second mask.

2. The method of claim 1, wherein the first mask corresponds to a defect area comprising pixels corresponding to defect scores greater than or equal to a threshold value among the defect scores.

3. The method of claim 2, wherein the threshold value is adjusted based on the augmented image.

4. The method of claim 2, wherein the generating of the second mask comprises:
identifying a pixel with a highest defect score and a pixel with a lowest defect score according to the array of the defect scores for each of the pixels;
identifying a third mask including the pixel with the lowest defect score;
identifying whether each of a plurality of the pixels is included in the third mask in a descending order from the pixel with the highest defect score; and
generating the second mask by using one or more pixels of the plurality of the pixels not included in the third mask.

5. The method of claim 4, wherein the generating of the second mask by using the one or more pixels not included in the third mask comprises:
determining information of the one or more pixels not included in the third mask; and
generating the second mask by using a prompt determined based on the determined information.

6. The method of claim 5, wherein the prompt comprises the information with respect to the one or more pixels and a bounding box corresponding to the defect area.

7. The method of claim 4, wherein the identifying of whether the each of the plurality of the pixels is included in the third mask comprises identifying whether the each of the plurality of the pixels is included in the third mask until a number of the one or more pixels not included in the third mask reaches a reference number.

8. The method of claim 1, wherein the generating of the augmented image based on the normal image and the one or more masks including either one or both of the first mask and the second mask comprises generating the augmented image based on the normal image and a mask in which the first mask and the second mask are combined.

9. The method of claim 1, wherein the generating of the augmented image based on the normal image and one or more masks including either one or both of the first mask and the second mask comprises generating the augmented image based on the normal image and one mask selected from among the first mask and the second mask depending on a defect type corresponding to the defect image.

10. The method of claim 1, wherein the augmented image is used for classifying the defect type corresponding to the defect image.

11. The method of claim 1, wherein the model corresponds to a segment anything model (SAM).

12. The method of claim 1, wherein the generating of the augmented image based on the normal image and the one or more masks including either one or both of the first mask and the second mask comprises:
adjusting one or more attributes including any one or any combination of any two or more of a size, a location, an angle, and a brightness of the one or more masks; and
generating the augmented image based on the normal image and the one or more masks with the adjusted one or more attributes.

13. The method of claim 1, further comprising training, using the generated augmented image, a defect detection model to detect a defect of an input image.

14. An electronic apparatus comprising:
one or more processors comprising processing circuitry; and
memory comprising one or more storage media storing instructions that, when executed individually or collectively by the one or more processors, cause the electronic device to:
generate a first mask corresponding to a defect area identified based on defect scores for each of pixels in heatmap information corresponding to a defect image;
generate a second mask from a model by using a prompt determined based on an array of the defect scores for each of the pixels; and
generate an augmented image based on a normal image and one or more masks including either one or both of the first mask and the second mask.

15. The electronic apparatus of claim 14, wherein the first mask corresponds to a defect area comprising pixels corresponding to defect scores greater than or equal to a threshold value among the defect scores for each of the pixels.

16. The electronic apparatus of claim 14, wherein, for the generating of the second mask, the execution of the instructions causes the electronic device to:
identify a pixel with a highest defect score and a pixel with a lowest defect score according to the array of the defect scores for each of the pixels;
identify a third mask including the pixel with the lowest defect score;
identify whether each of a plurality of the pixels is included in the third mask in a descending order from the pixel with the highest defect score; and
generate the second mask by using one or more pixels of the plurality of the pixels not included in the third mask.

17. The electronic apparatus of claim 16, wherein, for the generating of the second mask by using the pixel not included in the third mask, the execution of the instructions causes the electronic device to:
determine information of the one or more pixels not included in the third mask; and
generate the second mask by using a prompt determined based on the determined information.

18. The electronic apparatus of claim 17, wherein the prompt comprises the information with respect to the one or more pixels and a bounding box corresponding to the defect area.

19. The electronic apparatus of claim 17, wherein the execution of the instructions causes the electronic device to identify whether the each of the plurality of the pixels is included in the third mask until a number of the one or more pixels not included in the third mask reaches a reference number.

20. An electronic apparatus comprising:
one or more processors comprising processing circuitry; and
memory comprising one or more storage media storing instructions that, when executed individually or collectively by the one or more processors, cause the electronic device to detect a defect of an input image by using a defect detection model which has been trained based on an augmented image,
wherein the augmented image is an augmented image generated based on a normal image and one or more masks including either one or both of a first mask corresponding to a defect area identified based on defect scores for each of pixels in heatmap information corresponding to a defect image, and a second mask generated from a model by using a prompt determined based on an array of the defect scores for each of the pixels.
